(19) United States
(12) Patent Application Publication
(10) Pub. No.: US 2018/0094133 A1
(43) Pub. Date: Apr. 5, 2018

(54) INTERIOR/EXTERIOR AUTOMOTIVE TRIM COMPONENT

(71) Applicant: MAZDA MOTOR CORPORATION, Hiroshima (JP)

(72) Inventors: Yohei ICHIHARA, Hiroshima (JP); Atsushi FUJITA, Tokyo (JP); Hideki KINOSHITA, Tokyo (JP)

(73) Assignee: MAZDA MOTOR CORPORATION, Hiroshima (JP)

(21) Appl. No.: 15/718,839

(22) Filed: Sep. 28, 2017

(30) Foreign Application Priority Data
Sep. 30, 2016 (JP) 2016-193279
Sep. 26, 2017 (JP) 2017-184804

(51) Int. Cl. C08L 69/00

(52) U.S. Cl. CPC C08L 69/00; C08L 2201/08; C08L 2205/025

(57) ABSTRACT

Disclosed herein is an interior/exterior automotive trim component made of a thermoplastic resin composition including components (A)-(F), wherein relative to 100 parts by mass of the component (A), the component (B) such as a particular hindered phenol based antioxidant is 0.09-0.11 parts by mass, the component (C) such as dibutyl hydroxy toluene is 0.001-0.015 parts by mass, the component (D) such as tris(2,4-di-t-butylphenyl) phosphite is 0.04-0.06 parts by mass, the component (E) such as a particular benzotriazole based light stabilizer is 0.09-0.11 parts by mass, and the component (F) such as a particular hindered amine based light stabilizer is 0.09-0.11 parts by mass. The component (A) is a polycarbonate resin composition comprised of a molten mixture of a plurality of predetermined carbonate copolymers having respectively different copolymerization ratios.

### CROSS-REFERENCE TO RELATED APPLICATION

This application claims priority to Japanese Patent Application No. 2016-193279 filed on Sep. 30, 2016 and Japanese Patent Application No. 2017-184804 filed on Sep. 26, 2017, the entire disclosure of which is hereby incorporated by reference.

### BACKGROUND

The present disclosure relates to an interior/exterior automotive trim component comprised of a thermoplastic resin composition including a particular polycarbonate resin, a particular hindered phenol based antioxidant, dibutyl hydroxy toluene, tris(2,4-di-t-butylphenyl) phosphite, a particular benzotriazole based light stabilizer, and a particular hindered amine based light stabilizer.

An aromatic polycarbonate resin has been broadly used as an engineering plastic with excellent thermal resistance, impact resistance, and transparency in various applications including automobiles and office automation equipment, among other things. An aromatic polycarbonate resin is generally produced out of a raw material derived from petroleum resources. Recently, however, as concern about a possible depletion of such petroleum resources has been growing, there have been increasing demands for providing plastic molded products that use a raw material derived from a biomass resource such as a plant. In addition, people are also worrying about a significant climate change and other unbeneficial phenomena to be caused by global warming that has been advancing year after year due to emission and accumulation of increasing amounts of CO₂ gas. Thus, more and more people are waiting for development of plastic molded products made from a plant-derived monomer that can be carbon-neutral even when dumped after their use. The demand is particularly high in the field of large-sized molded products.

Meanwhile, various polycarbonate resins made from a plant-derived monomer have been developed.

For example, it was proposed to obtain a polycarbonate resin by using isosorbide as a plant-derived monomer and producing a transesterification between isosorbide and diphenyl carbonate (see, for example, United Kingdom Patent No. 1079686). Also, a polycarbonate resin obtained by copolymerizing isosorbide bisphenol A was proposed as a copolymerized polycarbonate of isosorbide and other dihydroxy compounds (see, for example, Japanese Unexamined Patent Publication No. S56-55425). Furthermore, an attempt was made to improve the stiffness of a homo-polycarbonate resin of isosorbide by copolymerizing isosorbide and aliphatic diol (see, for example, WO 04/111106).

Furthermore, it has been known that a molded product having high flowability and high thermal resistance, forming few flow marks, tiger marks, and other imperfections on its surface during an injection molding process, and exhibiting high impact resistance can be obtained by mixing together two or more polycarbonate resins having different compositions in each of which isosorbide and a dihydroxy compound are copolymerized together (see Japanese Unexamined Patent Publication No. 2014-208800).

Furthermore, it is described that a molded product with excellent transparency, light resistance, and hues can be made from a polycarbonate resin composition obtained by adding a hindered amine based light stabilizer to a polycarbonate resin including isosorbide (see WO 2011/118768).

However, there have been increasing demands for interior/exterior automotive trim components with further improved thermal resistance and light resistance. Thus, to meet such demands, the molded products described in Japanese Unexamined Patent Publication No. 2014-208800 and WO 2011/118768 are required to further improve their thermal resistance and light resistance when used as interior/exterior automotive trim components.

The present disclosure provides an interior/exterior automotive trim component with excellent thermal resistance and light resistance.

### SUMMARY

The present inventors carried out research and development to discover that a thermoplastic resin composition, obtained by melting and mixing a polycarbonate copolymer having a structural unit derived from a dihydroxy compound with a particular site with a plurality of carbonate copolymers having respectively different copolymerization ratios and including a particular hindered phenol based antioxidant, dibutyl hydroxy toluene, tris(2,4-di-t-butylphenyl) phosphite, a particular benzotriazole based light stabilizer, and a particular hindered amine based light stabilizer, had such excellent thermal resistance and light resistance, thus acquiring a basic idea of the present disclosure.

Specifically, the present disclosure is summarized as follows:

[1] An interior/exterior automotive trim component comprising a thermoplastic resin composition including components (A), (B), (C), (D), (E), and (F), wherein relative to 100 parts by mass of the component (A), the component (B) is 0.09-0.11 parts by mass, the component (C) is 0.001-0.015 parts by mass, the component (D) is 0.04-0.06 parts by mass, the component (E) is 0.09-0.11 parts by mass, and the component (F) is 0.09-0.11 parts by mass.

The component (A) is a polycarbonate resin composition comprised of a molten mixture of a plurality of carbonate copolymers having respectively different copolymerization ratios. The plurality of carbonate copolymers forming the polycarbonate resin composition are each comprised of structural units derived from two or more dihydroxy compounds. The component (A) includes, as the structural units derived from the dihydroxy compounds, a constitutional unit derived from a dihydroxy compound expressed by the following general formula (1) and a constitutional unit derived from cyclohexane dimethanol. The ratio of the content of the constitutional unit derived from the dihydroxy compound expressed by the following general formula (1) to that of the constitutional unit derived from cyclohexane dimethanol is represented as a molar ratio of 67/33 to 69/31.

The component (B) is a hindered phenol based antioxidant with a molecular weight of 1100-1200.

The component (C) is dibutyl hydroxy toluene.

The component (D) is tris(2,4-di-t-butylphenyl) phosphite.

The component (E) is a benzotriazole based light stabilizer with a melting point of 190-210° C.

The component (F) is a hindered amine based light stabilizer with a melting point of 125-135° C.

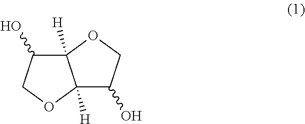

[2] The interior/exterior automotive trim component of [1], wherein the component (F) is a hindered amine based light stabilizer having a piperidine structure.

[3] The interior/exterior automotive trim component of [1] or [2], wherein the component (F) is a hindered amine based light stabilizer having a plurality of piperidine structures.

[4] The interior/exterior automotive trim component of [3], wherein the plurality of piperidine structures of the component (F) are linked to a single alkane chain via an ester bond.

According to the present disclosure, the use of a particular thermoplastic resin composition allows for providing an interior/exterior automotive trim component with excellent thermal resistance and light resistance.

### DETAILED DESCRIPTION

Embodiments of the present disclosure will now be described in detail. Note that the present disclosure is in no way limited to the embodiments to be described below but is readily modifiable in various manners without departing from the true spirit and scope of the present disclosure.

The present disclosure is directed to an interior/exterior automotive trim component comprising a thermoplastic resin composition including particular components in predetermined percentages.

[Thermoplastic Resin Composition]

The thermoplastic resin composition includes a particular polycarbonate resin composition (as component (A)), a particular hindered phenol based antioxidant (as component (B)), dibutyl hydroxy toluene (as component (C)), tris(2,4-di-t-butylphenyl) phosphite (as component (D)), a particular benzotriazole based light stabilizer (as component (E)), and a particular hindered amine based light stabilizer (as component (F)).

### Component (A) (Polycarbonate Resin Composition)

The component (A) is a polycarbonate resin composition comprised of a molten mixture of a plurality of carbonate copolymers.

Each of the plurality of carbonate copolymers, forming the polycarbonate resin composition, is a carbonate copolymer comprised of structural units derived from two or more dihydroxy compounds, i.e., a carbonate copolymer obtained by polymerizing together at least two different dihydroxy compounds.

Each of the plurality of carbonate copolymers described above includes, as its essential constitutional units, the following two structural units respectively derived from the two different dihydroxy compounds, among various structural units derived from the at least two different dihydroxy compounds.

One of these two essential constitutional units is a constitutional unit derived from a dihydroxy compound expressed by the following general formula (1) (hereinafter sometimes referred to as “Structural Unit (1)”) and the other essential constitutional unit is a structural unit derived from cyclohexane dimethanol.

The component (A) is a molten mixture of a plurality of carbonate copolymers, in which the polyol components described above (namely, the Structural Unit (1) and the structural unit derived from cyclohexane dimethanol) are copolymerized together at respectively different copolymerization ratios.

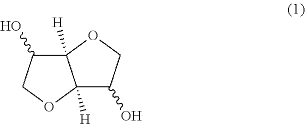

<Dihydroxy Compound Having Site Expressed by Formula (1)>

Examples of the dihydroxy compounds expressed by Formula (1) include isosorbide, isomannide, and isoidet, which are stereoisomers.

As for these dihydroxy compounds expressed by Formula (1), either a single dihydroxy compound may be used by itself or two or more dihydroxy compounds may be used in combination.

Among these dihydroxy compounds expressed by Formula (1), it is recommended to use isosorbide obtained by dehydration and condensation of sorbitol which is existent in profusion as a resource, easily available, and produced from various kinds of starch. The reason is that isosorbide is easily available and produced and has beneficial optical properties and moldability.

<Cyclohexane Dimethanol>

Specific examples of the cyclohexane dimethanol include 1,2-cyclohexane dimethanol, 1,3-cyclohexane dimethanol, and 1,4-cyclohexane dimethanol.

<Diester Carbonate>

The polycarbonate resin may be produced by a general polymerization method, which may be either interface polymerization using carbonyl chloride or melt polymerization that induces transesterification with respect to diester carbonate. It is recommended, however, to adopt the melt polymerization that allows the dihydroxy compound to react to diester carbonate having less toxicity to the environment under the presence of a polymerization catalyst.

In this case, the polycarbonate resin may be obtained by the melt polymerization that induces transesterification between dihydroxy compounds, including at least the dihydroxy compound expressed by the general formula (1) and cyclohexane dimethanol, and diester carbonate.

Diester carbonate to be used may generally be the compound expressed by the following Formula (2). Only one of these diester carbonate compounds may be used alone. Alternatively, two or more of the diester carbonate compounds may be mixed together.

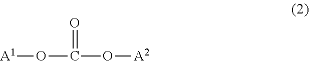

In Formula (2), A¹ and A² independently represent substituted or non-substituted aliphatic groups having a carbon number of 1 to 18 or substituted or non-substituted aromatic groups.

Examples of the diester carbonate expressed by Formula (2) include substituted diphenyl carbonates such as diphenyl carbonate and ditolyl carbonate, dimethyl carbonate, diethyl carbonate, and di-t-butyl carbonate. The diester carbonate is suitably a substituted diphenyl carbonate such as diphenyl carbonate, and more suitably diphenyl carbonate. The diester carbonate may include an impurity such as a chloride ion which may inhibit the polymerization reaction or deteriorate the hue of the resulting polycarbonate resin in some cases. Thus, the diester carbonate is suitably a refined (e.g., distilled) one depending on the necessity.

The diester carbonate is suitably used at a molar ratio of 0.90 to 1.20, more suitably at a molar ratio of 0.95 to 1.10, even more suitably at a molar ratio of 0.96 to 1.10, and particularly suitably at a molar ratio of 0.98 to 1.04, with respect to all dihydroxy compounds used for the melt polymerization.

If this molar ratio were less than 0.90, the number of terminal hydroxyl groups of the resultant polycarbonate resin would increase so much as to affect the thermal stability of the polymer, could make the thermoplastic resin composition being molded colored, could cause a decrease in transesterification rate, or could prevent the desired high molecular weight resin from being obtained.

However, if the molar ratio were greater than 1.20, then the transesterification rate would decrease too much under the same condition to produce the polycarbonate resin at a desired molecular weight easily. In addition, in that case, an increased amount of diester carbonate would remain in the polycarbonate resin produced to emit an odor either during the molding process or out of the molded product, which is not beneficial. This would increase the thermal history during the polymerization reaction so much that the resultant polycarbonate resin could have deteriorated hue or weatherability.

Furthermore, as the molar ratio of the diester carbonate with respect to all of the dihydroxy compounds increases, the amount of diester carbonate remaining in the resultant polycarbonate resin increases and may absorb an ultraviolet ray increasingly to deteriorate the weatherability of the polycarbonate resin, which is not beneficial. According to the present disclosure, the concentration of the diester carbonate remaining in the polycarbonate resin is suitably 200 ppm by mass or less, more suitably 100 ppm by mass or less, even more suitably 60 ppm by mass or less, and particularly suitably 30 ppm by mass or less. Actually, however, a polycarbonate resin sometimes includes an unreacted diester carbonate. Such an unreacted diester carbonate in a polycarbonate resin ordinarily has a lower limit of 1 ppm by mass.

<Transesterification Catalyst>

A polycarbonate resin according to the present disclosure may be produced by causing transesterification between dihydroxy compounds including the dihydroxy compound (1) and the diester carbonate expressed by Formula (2) as described above. More specifically, the polycarbonate resin is obtained by causing the transesterification such that mono-hydroxy compounds produced as side products are removed out of the system. In this case, the melt polymerization is generally produced by causing the transesterification under the presence of a transesterification catalyst.

Examples of the transesterification catalyst (hereinafter sometimes simply referred to as a “catalyst”) for use during the manufacturing process of the polycarbonate resin of the present disclosure include Group I metal compounds, Group II metal compounds, and various basic compounds such as basic boron compounds, basic phosphorus compounds, basic ammonium compounds, and amine-based compounds in the long periodic table (see Nomenclature of Inorganic Chemistry IUPAC Recommendations 2005). It is recommended that Group I metal compounds and/or Group II metal compounds be adopted, among these compounds.

Optionally, it is possible to use any suitable basic compound such as a basic boron compound, a basic phosphorus compound, a basic ammonium compound, or an amine based compound as a supplement to the Group I metal compound and/or Group II metal compound. Still, it is recommended that the Group I metal compound and/or the Group II metal compound be used alone.

Also, the Group I metal compound and/or Group II metal compound are/is normally used in the form of a hydroxide or a salt such as a carbonate, a carboxylate, or a phenolate. Considering their availability and the easiness of their handling, hydroxides, carbonates, and acetates are suitably adopted, and acetates are more suitably used in view of their hue and polymerization activity.

Examples of the Group I metal compounds include sodium hydroxide, potassium hydroxide, lithium hydroxide, cesium hydroxide, sodium hydrogen carbonate, potassium hydrogen carbonate, lithium hydrogen carbonate, cesium hydrogen carbonate, sodium carbonate, potassium carbonate, lithium carbonate, cesium carbonate, sodium acetate, potassium acetate, lithium acetate, cesium acetate, sodium stearate, potassium stearate, lithium stearate, cesium stearate, sodium borohydride, potassium borohydride, lithium borohydride, cesium borohydride, sodium tetraphenyl borate, potassium tetraphenyl borate, lithium tetraphenyl borate, cesium tetraphenyl borate, sodium benzoate, potassium benzoate, lithium benzoate, cesium benzoate, disodium hydrogen phosphate, dipotassium hydrogen phosphate, dilithium hydrogen phosphate, dicesium hydrogen phosphate, disodium phenyl phosphate, dipotassium phenyl phosphate, dilithium phenyl phosphate, dicesium phenyl phosphate, alcoholates and phenolates of sodium, potassium, lithium, and cesium, and disodium, dipotassium, dilithium and dicesium salts of bisphenol A. Among other things, cesium compounds and lithium compounds are suitably used.

Examples of the Group II metal compounds include calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate. Among other things, magnesium compounds, calcium compounds, and barium compounds are suitably used, and magnesium compounds and/or calcium compounds are more suitably used.

Examples of the basic boron compounds include, sodium, potassium, lithium, calcium, barium, magnesium and strontium salts of tetramethylboron, tetraethylboron, tetrapropylboron, tetrabutylboron, trimethylethylboron, trimethylbenzylboron, trimethylphenylboron, triethylmethylboron, triethylbenzylboron, triethylphenylboron, tributylbenzylboron, tributylphenylboron, tetraphenylboron, benzyltriphenylboron, methyltriphenylboron and butyltriphenylboron.

Examples of the basic phosphorus compounds include triethylphosphine, tri-n-propylphosphine, triisopropylphosphine, tri-n-butylphosphine, triphenylphosphine, tributylphosphine, and a quaternary phosphonium salt.

Examples of the basic ammonium compounds include tetramethylammonium hydroxide, tetraethylammonium hydroxide, tetrapropylammonium hydroxide, tetrabutylammonium hydroxide, trimethylethylammonium hydroxide, trimethylbenzylammonium hydroxide, trimethylphenylammonium hydroxide, triethylmethylammonium hydroxide, triethylbenzylammonium hydroxide, triethylphenylammonium hydroxide, tributylbenzylammonium hydroxide, tributylphenylammonium hydroxide, tetraphenylammonium hydroxide, benzyltriphenylammonium hydroxide, methyltriphenylammonium hydroxide, and butyltriphenylammonium hydroxide.

Examples of the amine-based compounds include 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, and aminoquinoline.

Of these compounds, a least one metal compound selected from the group consisting of the Group II metal compounds and the lithium compounds is suitably used as the catalyst to obtain a polycarbonate resin with excellent physical properties in terms of transparency, hue and light resistance, for example.

Also, to allow the polycarbonate resin to have particularly good transparency, hue and light resistance, the catalyst is suitably at least one metal compound selected from the group consisting of magnesium compounds, calcium compounds, and barium compounds, more suitably at least one metal compound selected from the group consisting of magnesium compounds and calcium compounds.

If the catalyst used is a Group I metal compound and/or a Group II metal compound, the amount of the catalyst used and converted into the amount of the metal generally falls within the range of 0.1 to 300 μmol, suitably within the range of 0.1 to 100 μmol, more suitably within the range of 0.5 to 50 μmol, and particularly suitably within the range of 1 to 25 μmol, with respect to one mole of every dihydroxy compound used for reaction.

Among other things, if the catalyst used is a compound including at least one metal selected from the group consisting of the Group II metal compounds, the amount of the catalyst used and converted into the amount of the metal is suitably equal to or greater than 0.1 μmol, more suitably equal to or greater than 0.5 μmol, and even more suitably equal to or greater than 0.7 μmol, with respect to one mole of every dihydroxy compound used for reaction. Also, the upper limit is suitably 20 μmol, more suitably 10 μmol, even more suitably 3 μmol, and particularly suitably 2.0 μmol.

If the catalyst used were too little, the polymerization reaction would not be activated enough to produce a polycarbonate resin in a desired molecular weight or produce sufficient fracture energy. On the other hand, if the catalyst used were too much, not only the hue of the resulting polycarbonate resin would deteriorate but also some byproducts would be produced to cause a decrease in flowability and produce a gel more frequently. This may sometimes cause a brittle fracture and make it difficult to produce a polycarbonate resin of a target quality.

<Method of Producing Polycarbonate Resin>

The polycarbonate resin is obtained by melting and polymerizing together dihydroxy compounds, including the dihydroxy compound expressed by the general formula (1) and cyclohexane dimethanol, and a diester carbonate via transesterification. The dihydroxy compound and the diester carbonate that are the materials of the polycarbonate resin are suitably mixed uniformly together before being subjected to the transesterification.

The temperature of the materials being mixed is generally at least equal to 80° C. and suitably 90° C. or more. The upper limit of the temperature is generally not greater than 250° C., suitably 200° C. or less, and more suitably 150° C. or less. Among other things, the temperature particularly suitably falls within the range of 100° C. to 120° C. If the mixing temperature were too low, then the rate of solution could be too low or the solubility could be insufficient, thus often resulting in solidification and other inconveniences. However, if the mixing temperature were too high, then the dihydroxy compound could be degraded thermally in some cases, and the resultant polycarbonate resin could have its hue deteriorated and its light resistance affected negatively.

The polycarbonate resin is suitably produced by going through the melt polymerization in multiple stages under the presence of a catalyst using a plurality of reactors.

The type of the reaction may be any of a batch type, a continuous type, or a combination of the batch type and the continuous type.

Furthermore, it is effective to use a reflux condenser as the polymerization reactor to reduce the amount of the monomer distillated. The use of a reflux condenser is particularly effective in the reactor in an initial stage of polymerization in which there are a lot of unreacted monomer components.

To maintain an appropriate polymerization rate and to avoid a decline in the hue, thermal stability, light resistance, or any other property of the resultant polycarbonate resin while reducing the distillation of the monomer, it is meaningful to select an appropriate type of catalyst as the catalyst and use the catalyst in an appropriate amount.

If two or more of the reactors are used to produce the polycarbonate resin, multiple reaction stages to be carried out under different conditions may be defined, or the temperature and/or pressure may be changed continuously, in those reactors.

While the polycarbonate resin is being produced, the catalyst may be either added to the material preparing vessel or material reservoir or added directly to the reactors. From the standpoints of the stability of supply and control of the melt polymerization, a catalyst supply line may be disposed halfway through a line of the materials yet to be supplied to the reactors, and the materials are suitably supplied in the form of an aqueous solution.

Regarding polymerization conditions, in an initial stage of the polymerization, the polymerization is suitably conducted at a relatively low temperature and under a relatively low vacuum to obtain a prepolymer. Meanwhile, in a late stage of the polymerization, the polymerization is suitably conducted at a relatively high temperature and under a relatively high vacuum to raise the molecular weight to a predetermined value. It is, however, beneficial from the standpoints of hue and light resistance of the polycarbonate resin to be obtained that a jacket temperature, an internal temperature, and an internal pressure of the reaction system are appropriately selected at each molecular-weight stage. For example, if either the temperature or the pressure were changed too quickly before the polymerization reaction reaches a predetermined value, an unreacted monomer would be distilled off to alter the molar ratio of the dihydroxy compounds to the diester carbonate. This could result in a decrease in polymerization rate or make it impossible to obtain a polymer having a predetermined molecular weight or intended terminal groups, thus possibly hampering an object of the present disclosure from being achieved.

The transesterification temperature should not be too low, because such a temperature would lead to a decline in productivity and an increase in the thermal history of the product. Nevertheless, the transesterification temperature should not be too high, either, because such a temperature would not only cause the vaporization of the monomer but also promote the decomposition and coloring of the polycarbonate resin as well.

In producing the polycarbonate resin, the method of causing the transesterification between dihydroxy compounds, including the dihydroxy compound expressed by the general formula (1) and cyclohexane dimethanol, and diester carbonate under the presence of a catalyst is generally carried out as a multi-stage process consisting of two or more stages.

If the transesterification temperature were excessively high, the hue would deteriorate when the materials are formed into a molded product, thus possibly increasing the chances of brittle fracture. However, if the transesterification temperature were too low, then the target molecular weight could not rise, the molecular weight distribution could become too broad, and the impact resistance could be insufficient in some cases. Furthermore, if the residence time of the transesterification were too long, then the brittle fracture ratio could tend to increase in some cases. Meanwhile, if the residence time were too short, then the target molecular weight could not rise and the impact resistance could be insufficient in some cases.

Particularly, to obtain a good polycarbonate resin having a high impact strength with the coloring, thermal degradation or scorching thereof minimized, the maximum internal temperature in the reactors on every reaction stage is suitably lower than 255° C., more suitably 250° C. or less, and particularly falls within the range of 225 to 245° C. To prevent the polymerization rate from dropping significantly during the second half of the polymerization reaction and to minimize the thermal degradation of the polycarbonate resin due to the thermal history, a horizontal reactor having good plug flowability and surface renewability is suitably used during the last stage of the reaction.

Also, Group I metals such as lithium, sodium, potassium or cesium, particularly, sodium, potassium, or cesium, among other things, may enter the polycarbonate resin from not only the catalyst used but also the raw materials or the reactors in some cases. Considering that these metals could affect the hue negatively when included a lot in the polycarbonate resin, the total content of these compounds in the polycarbonate resin of the present disclosure is suitably as small as possible. Thus, the content of these metals in the polycarbonate resin is generally not greater than 1 ppm by mass, suitably 0.8 ppm by mass or less, and more suitably 0.7 ppm by mass or less.

The content of the metals in the polycarbonate resin may be measured by any of various known methods. For example, after the metals in the polycarbonate resin have been recovered by a technique such as wet ashing, the content of the metals may be measured by a technique such as atomic emission, atomic absorption, or inductively coupled plasma (ICP) spectroscopy.

After having been subjected to the melt polymerization as described above, the polycarbonate resin of the present disclosure is usually cooled and solidified, and then pelleted with a rotary cutter, for example.

Any arbitrary pelleting method may be adopted. For example, any of the following methods may be used. Specifically, the polycarbonate resin in a molten state may be removed from the last polymerization reactor, and then cooled and solidified in the form of strands such that the polycarbonate resin thus solidified is pelleted. Alternatively, the resin in a molten state may be supplied from the last polymerization reactor to a uniaxial or biaxial extruder so as to be extruded in the molten state, and then cooled and solidified such that the polycarbonate resin thus solidified is pelleted. Still alternatively, the polycarbonate resin in a molten state may be removed from the last polymerization reactor, and cooled and solidified in the form of strands such that the polycarbonate resin thus solidified is pelleted once. After that, the resin may be supplied again to a uniaxial or biaxial extruder, extruded in a molten state, and then cooled and solidified such that the polycarbonate resin thus solidified is pelleted.

During this process, in the extruder, the monomer remaining there may be devolatilized under a reduced pressure, and/or any agent selected from the group consisting of generally known thermal stabilizers, neutralizers, ultraviolet absorbers, mold release agents, colorants, antistatic agents, slip additives, lubricants, plasticizers, compatibilizers, and flame retardants may also be added and kneaded together.

The temperature of the melt kneading process to be performed in the extruder varies depending on the glass transition temperature and molecular weight of the polycarbonate resin, but normally falls within the range of 150 to 300° C., suitably within the range of 200 to 270° C., and more suitably within the range of 230 to 260° C. If the melt kneading temperature were lower than 150° C., then the polycarbonate resin would have so high melt viscosity as to impose too heavy load on the extruder to avoid a decline in productivity. However, if the melt kneading temperature were higher than 300° C., then the polycarbonate resin would be thermally degraded so significantly that its mechanical strength would decrease due to a decline in its molecular weight, the resin would be colored or emit a gas, foreign substances would enter the resin, or the resin would get scorched. Thus, to eliminate such foreign substances or scorching, it is recommended that a filter be disposed either in the extruder or at the outlet of the extruder.

Also, one or more thermal stabilizers may be added to the polycarbonate resin thus produced in order to substantially avoid a decline in the molecular weight during the molding process and deteriorated hue.

Examples of such thermal stabilizers include phosphorous acid, phosphoric acid, phosphonous acid, and phosphonic acid.

An amount of the thermal stabilizer may be further added, even after the thermal stabilizer has been added during the melt polymerization. Specifically, a phosphorous acid compound may be added by the mixing method to be described later after a polycarbonate resin has been obtained with an appropriate amount of a phosphorous or phosphoric acid compound added. This allows addition of an even larger amount of the thermal stabilizer with a decrease in transparency or thermal resistance minimized and with coloring avoided during the polymerization, thus substantially preventing the hue from deteriorating.

The content of any of these thermal stabilizers relative to 100 parts by mass of the polycarbonate resin is suitably in the range of 0.0001 to 1.0 parts by mass, more suitably in the range of 0.0005 to 0.5 parts by mass, and even more suitably in the range of 0.001 to 0.2 parts by mass.

<Physical Properties of Polycarbonate Resin>

The physical properties that the polycarbonate resin of the present disclosure suitably has will be described below.

(Glass Transition Temperature)

The polycarbonate resin of the present disclosure has a glass transition temperature (Tg) of less than 145° C. If the glass transition temperature of the polycarbonate resin were over this range, then the polycarbonate resin would be colored easily and it could be difficult to increase its impact resistance. Also, in that case, the temperature of a die should be set to be high when the surface shape of the die is transferred onto the molded product during the molding process. This might limit the types of usable temperature controllers or could deteriorate the transferability of the die surface shape.

The polycarbonate resin of the present disclosure suitably has a glass transition temperature of less than 140° C., and more suitably less than 135° C.

Furthermore, the glass transition temperature of the polycarbonate resin according to the present disclosure is generally at least equal to 90° C., and suitably equal to or higher than 95° C.

Examples of techniques for making the glass transition temperature of the polycarbonate resin according to the present disclosure less than 145° C. include decreasing the ratio of the Structural Unit (1) in the polycarbonate resin, selecting an alicyclic dihydroxy compound with low thermal resistance as the dihydroxy compound for use to produce the polycarbonate resin, and decreasing the ratio of the structural unit derived from an aromatic dihydroxy compound such as a bisphenol compound in the polycarbonate resin.

Note that the glass transition temperature of the polycarbonate resin according to the present disclosure was measured by the method to be described later for the examples of the present disclosure.

(Reduced Viscosity)

The degree of polymerization of the polycarbonate resin of the present disclosure may be represented as a reduced viscosity to be measured at a temperature of 30.0° C.±0.1° C. (hereinafter sometimes simply referred to as “reduced viscosity”) by precisely adjusting the concentration of the polycarbonate resin to 1.00 g/dl using, as a solvent, a mixed solvent in which phenol and 1,1,2,2-tetrachloroethane are mixed together at a mass ratio of one to one. The reduced viscosity is suitably at least equal to 0.40 dl/g, more suitably equal to or greater than 0.42 dl/g, and particularly suitably equal to or greater than 0.45 dl/g. Depending on its application, the thermoplastic resin composition of the present disclosure suitably has a reduced viscosity of at least 0.60 dl/g, or even equal to or greater than 0.85 dl/g. Meanwhile, the reduced viscosity of the polycarbonate resin according to the present disclosure is suitably not greater than 2.0 dl/g, more suitably equal to or less than 1.7 dl/g, and particularly suitably equal to or less than 1.4 dl/g. If the polycarbonate resin had too low a reduced viscosity, then the polycarbonate resin could sometimes have significantly decreased mechanical strength. Meanwhile, if the polycarbonate resin had too high a reduced viscosity, then the polycarbonate resin would have a decreased degree of flowability and deteriorated cycle characteristic during the molding process and would tend to increase the strain of, and more easily thermally deform, the molded product.

[Mixing Polycarbonate Resins]

The component (A) of the present disclosure is a molten mixture of a plurality of carbonate copolymers having respectively different copolymerization ratios. The temperature of this molten mixture (represented as the temperature of the resin measured at the melt extruding port) may fall within the range of 235° C. to 245° C., and suitably falls within the range of 238° C. to 242° C. Setting the temperature of the molten mixture within either of these ranges allows for reducing coloring, thermal degradation, or scorching of the polycarbonate resins, thus providing a mixture of good polycarbonate resins with high impact resistance.

The range of the respectively different copolymerization ratios of the carbonate copolymers and the mixing ratio of the plurality of polycarbonate copolymers are appropriately selected such that the copolymerization ratio of the polycarbonate resin mixture obtained by the mixing process (i.e., the average copolymerization ratio obtained by dividing those of the different carbonate copolymers by the mixing ratio) falls within a predetermined range. As the copolymerization ratio of the polycarbonate resin mixture obtained by the mixing process, the ratio of the mole number of the Structural Unit (1) to the total mole number of the Structural Unit (1) and the structural unit derived from cyclohexane dimethanol is equal to or greater than 67 mol %, and suitably equal to or greater than 67.5 mol %. Furthermore, its upper limit is not greater than 69 mol % and suitably equal to or less than 68.5 mol %. Also, the ratio of the mole number of the structural unit derived from cyclohexane dimethanol to the total mole number mentioned above is not less than 31 mol %, and suitably equal to or greater than 31.5 mol %. Furthermore, its upper limit is not greater than 33 mol % and suitably equal to or less than 32.5 mol %.

If the ratio of the mole number of the Structural Unit (1) to the total mole number were less than 56 mol % (i.e., if the ratio of the mole number of the structural unit derived from cyclohexane dimethanol to the total mole number were greater than 44 mol %), then the thermal resistance could decline, which is a problem. If the ratio of the mole number of the Structural Unit (1) to the total mole number were greater than 69 mol % (i.e., if the ratio of the mole number of the structural unit derived from cyclohexane dimethanol to the total mole number were less than 31 mol %), then the impact resistance could decline, which is a problem.

### Component (B) (Particular Hindered Phenol Based Antioxidant

The thermoplastic resin composition according to the present disclosure includes, as the component (B) to be added to the component (A), a hindered phenol based antioxidant having a particular molecular weight.

The hindered phenol based antioxidant has a molecular weight of at least 1100 and suitably has a molecular weight of 1120 or more. If its molecular weight were less than 1100, its effect of reducing deterioration due to oxidation would be insufficient. On the other hand, the upper limit of the molecular weight may be not greater than 1200 and is suitably 1180. If the upper limit of the molecular weight were greater than 1200, the resultant resin composition would have a low degree of compatibility.

Examples of such a hindered phenol based antioxidant with a molecular weight of 1100-1200 include compounds such as pentaerythritol tetrakis [3-(3,5-di-tert-butyl-4-hydroxyphenyl) propionate].

The content of the component (B) may be not less than 0.09 parts by mass, and is suitably equal to or greater than 0.094 parts by mass, and more suitably equal to or greater than 0.096 parts by mass, relative to 100 parts by mass of the component (A). The content of the component (B) added is suitably equal to or greater than 0.09 parts by mass, because the effect of improving the surface impact resistance and the impact resistance would be enhanced easily in that case. On the other hand, the upper limit of the content of the component (B) may be not greater than 0.11 parts by mass, and is suitably equal to or less than 0.108 parts by mass, and more suitably equal to or less than 0.106 parts by mass. The upper limit of the content of the component (B) added is suitably equal to or less than 0.11 parts by mass to improve the appearance and thermal resistance of the molded product, which is an exemplary interior/exterior automotive trim component according to the present disclosure.

### Component (C) (Dibutyl Hydroxy Toluene)

The thermoplastic resin composition according to the present disclosure includes, as the component (C) to be added to the component (A), dibutyl hydroxy toluene. Adding this component allows for curbing a decline in the molecular weight during a weatherability test (i.e., improving the weatherability).

The content of the component (C) may be not less than 0.001 parts by mass, and is suitably equal to or greater than 0.015 parts by mass, relative to 100 parts by mass of the component (A). If the content of the component (C) were less than 0.001 parts by mass, then the decline in the molecular weight during the weatherability test would not be curbed sufficiently effectively. On the other hand, the upper limit of the content of the component (C) may be not greater than 0.015 parts by mass, and is suitably equal to or less than 0.01 parts by mass. If the content of the component (C) were greater than 0.015 parts by mass, then the substance deposited on the die would increase.

### Component (D) (Tris(2,4-di-t-butylphenyl) Phosphite)

The thermoplastic resin composition according to the present disclosure includes, as the component (D) to be added to the component (A), tris(2,4-di-t-butylphenyl) phosphite.

The content of the component (D) may be not less than 0.04 parts by mass, and is suitably equal to or greater than 0.045 parts by mass, relative to 100 parts by mass of the component (A). The content of the component (D) added is suitably equal to or greater than 0.04 parts by mass, because the effect of improving the surface impact resistance and the impact resistance would be enhanced easily in that case. On the other hand, the upper limit of the content of the component (D) may be not greater than 0.06 parts by mass, and is suitably equal to or less than 0.055 parts by mass. The upper limit of the content of the component (D) added is suitably equal to or less than 0.06 parts by mass to improve the appearance and thermal resistance of the molded product, which is an exemplary interior/exterior automotive trim component according to the present disclosure.

### Component (E) (Benzotriazole Based Light Stabilizer with Predetermined Melting Point)

The thermoplastic resin composition according to the present disclosure includes, as the component (E) to be added to the component (A), a benzotriazole based light stabilizer with a predetermined melting point. Adding this component allows for curbing a decline in the molecular weight during a weatherability test.

The melting point of the benzotriazole based light stabilizer is not less than 190° C., and is suitably equal to or higher than 192° C. If the melting point of the component (E) were less than 190° C., then the light resistance would decline. On the other hand, the upper limit of the melting point of the component (E) may be not greater than 210° C., and is suitably equal to or less than 208° C. If the upper limit of the melting point were higher than 210° C., the resultant resin composition would have a low degree of compatibility.

More specific examples of benzotriazole based light stabilizers having a melting point of 190-210° C. include 2,2′-methylene bis[6-(2H-benzotriazole-2-il)-4-tert-octylphenol] and 3,5-di-tert-butyl-4-hydroxy-(2,4-di-tert-butylphenyl) benzoate.

The content of the component (E) may be not less than 0.09 parts by mass, and is suitably equal to or greater than 0.095 parts by mass, relative to 100 parts by mass of the component (A) of the present disclosure. If the content of the component (E) were less than 0.09 parts by mass, then the discoloration of the coloring agent would not be prevented sufficiently effectively. On the other hand, the upper limit of the content of the component (E) may be not greater than 0.11 parts by mass, and is suitably equal to or less than 0.105 parts by mass. If the content of the component (E) were greater than 0.11 parts by mass, then the substance deposited on the die would increase.

### Component (F) (Hindered Amine Based Light Stabilizer with Predetermined Melting Point)

The thermoplastic resin composition according to the present disclosure includes, as the component (F) to be added to the component (A), a hindered amine based light stabilizer with a predetermined melting point. Adding this component allows for curbing a decline in the molecular weight during a weatherability test.

The melting point of the hindered amine based light stabilizer is not less than 125° C., and is suitably equal to or greater than 127° C. If the melting point of the component (F) were lower than 125° C., then the light resistance would decline. On the other hand, the upper limit of the melting point of the component (F) may be not greater than 135° C., and is suitably equal to or less than 133° C. If the upper limit of the melting point were higher than 135° C., the resultant resin composition would have a low degree of compatibility.

The hindered amine based light stabilizer having a melting point of 125-135° C. suitably has a structure in which nitrogen forms part of a cyclic structure, and more suitably has a piperidine structure. The piperidine structure defined herein may be any structure as long as the structure has a saturated six-membered ring amine structure, and includes a piperidine structure partially replaced with a substituent group. The substituent group that the piperidine structure may have may be an alkyl group having a carbon number of 4 or less, and is suitably a methyl group, in particular. Furthermore, the amine compound is suitably a compound having a plurality of piperidine structures. In such a compound, those piperidine structures are suitably linked to a single alkane chain via an ester structure. A specific example of such a hindered amine based light stabilizer may be a compound expressed by the following Formula (3):

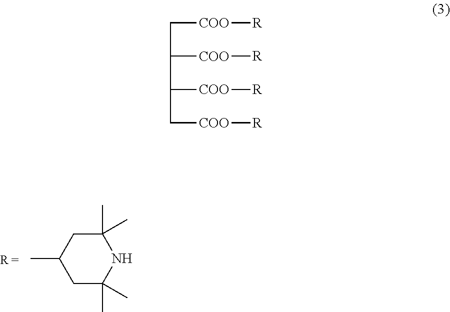

The content of the component (F) may be not less than 0.09 parts by mass, and is suitably equal to or greater than 0.095 parts by mass, relative to 100 parts by mass of the component (A) of the present disclosure. If the content of the component (F) were less than 0.09 parts by mass, then the discoloration of the coloring agent would not be prevented sufficiently effectively. On the other hand, the upper limit of the content of the component (F) may be not greater than 0.11 parts by mass, and is suitably equal to or less than 0.105 parts by mass. If the content of the component (F) were greater than 0.11 parts by mass, then the substance deposited on the die would increase.

[Method of Producing Thermoplastic Resin Composition]

The components (A)-(F) described above may be blended together by a method in which they are mixed and kneaded together with a tumbler, a V-blender, a super mixer, a Nauta mixer, a Banbury mixer, a kneading roll, or an extruder, or by a solution blending method in which they are mixed together while being dissolved in a common good solvent such as methylene chloride. However, the present disclosure is not limited to any particular blending method, but any of various general blending methods may be adopted arbitrarily.

Specifically, the pelleted component (A) and the various other components may be blended together with an extruder, extruded in the form of strands, and then cut into pellets with a rotary cutter, for example, to obtain the thermoplastic resin composition of the present disclosure.

The thermoplastic resin composition thus obtained according to the present disclosure may be molded into a desired shape in the following manner. Specifically, the respective components may be mixed together, and then the mixture is once pelleted either directly or through a melt extruder. After that, the pellets thus obtained may be molded by a generally known forming process such as extrusion, injection molding, or compression.

[Polycarbonate Resin Molded Product]

Molding the thermoplastic resin composition of the present disclosure allows an interior/exterior automotive trim component according to the present disclosure to be obtained.

The interior/exterior automotive trim component of the present disclosure is suitably molded by an injection molding process.

In that case, the interior/exterior automotive trim component of the present disclosure can be molded into a complex shape.

### EXAMPLES

Next, the present disclosure will be described in further detail by way of illustrative examples. Note that the present disclosure is in no way limited to the following examples. First of all, an evaluation method will be described.

<Evaluation Method>

(1) Measurement of Deflection Temperature Under Load

A pellet of a thermoplastic resin composition was dried at 80° C. for six hours with a hot air drier. Next, the pellet of the polycarbonate copolymer or resin composition thus dried was supplied to an injection molding machine (J75EII manufactured by the Japan Steel Works, Ltd.), thereby forming an ISO test piece to evaluate its mechanical and physical properties at a resin temperature of 240° C., a die temperature of 60° C., and a molding cycle time of 40 seconds. Then, the ISO test piece to evaluate the mechanical and physical properties thus obtained had its deflection temperature under load measured under a load of 1.80 MPa by a method compliant with the ISO75 standard.

(2) Light Resistance Test (ΔE*)

In compliance with the JIS B7753 standard, sunshine weatherometer S80, manufactured by Suga Test Instruments Co., Ltd. and having a sunshine carbon arc illuminator (four pairs of ultralong-life carbon arc lamps), was used to irradiate a square surface of an injection-molded flat plate (60 mm (width)×60 mm (length)×3 mm (thickness)) with light for 700 hours and 1000 hours, respectively, at a discharge voltage of 50 V and a discharge current of 60 A in the irradiation and surface spraying (rainfall) mode under conditions including a black panel temperature of 63° C. and a relative humidity of 50%. The period of surface spraying (rainfall) was set to be 12 minutes per hour. The glass filter used was a type A. In compliance with the JIS Z8722 standard, L*a*b* was measured after the irradiation process and ΔE* was calculated based on the values obtained before the test.

(3) Comprehensive Judgment

A thermoplastic resin composition with a deflection temperature under load of not less than 94° C. and a light resistance test result ΔE* of not greater than 2.2 was judged to be a GO ∘. Otherwise, the resin composition was judged to be a NO-GO x.

<Raw Materials>

### Material for Polycarbonate Resin Mixture (Component (A))

ISB: isosorbide (trade name POLYSORB manufactured by Rocket Frères Sa.)

CHDM: cyclohexane dimethanol (manufactured by Eastman Chemical Company)

D7340R: isosorbide polycarbonate (ISB/CHDM=70/30; manufactured by Mitsubishi Chemical Corporation)

D5380R: isosorbide polycarbonate (ISB/CHDM=50/50; manufactured by Mitsubishi Chemical Corporation)

### Hindered Phenol Based Antioxidant with Molecular Weight of 1100-1200 (Component (B))

Irganox1010: pentaerythritol tetrakis [3-(3,5-di-tert-butyl-4-hydroxyphenyl) propionate](manufactured by BASF in Japan)

### Dibutyl Hydroxy Toluene (Component (C))

BHT: dibutyl hydroxy toluene (trade name: YOSHINOX BHT manufactured by API Corporation)

### Tris(2,4-di-t-butylphenyl) Phosphite (Component (D))

AS2112: tris(2,4-di-t-butylphenyl) phosphite (manufactured by ADEKA Corporation)

### Benzotriazole Based Light Stabilizer with Melting Point of 190-210° C. (Component (E))

LA31: 2,2′-methylene bis[6-(2H-benzotriazole-2-il)-4-tert-octylphenol] (manufactured by ADEKA Corporation)

<Other Benzotriazole Based Light Stabilizers>

LA-29: 2-(2-hydroxy-5-tert-octylphenyl) benzotriazole (manufactured by ADEKA Corporation)

### Hindered Amine Based Light Stabilizer with Melting Point of 125-135° C. (Component (F))

LA57: HALS (trade name: LA-57 manufactured by ADEKA Corporation; compound expressed by the following Formula (3))

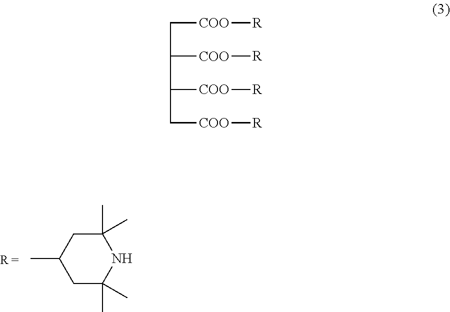

<Other Hindered Amine Based Light Stabilizers>

Tinuvin770DF: (trade name: TINUVIN770DF manufactured by BASF in Japan;
compound expressed by the following Formula (4))

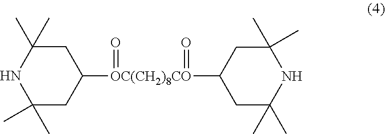

### First and Second Examples

Pellets of Component (A) shown in the following Table 1 were used, the respective components were mixed together to have the formulation of the thermoplastic resin composition shown in Table 1, and Solvent Green 3, Solvent Red 179, Solvent Blue 97, and Solvent Violet 36 were further added to the mixture to make the resultant thermoplastic resin composition have an L* value of 1.2. Thereafter, a biaxial extruder with two vent ports (trade name: LABOTEX 30HSS-32 manufactured by the Japan Steel Works, LTD.) was used to extrude the resin composition in the form of strands such that the resin would have a temperature of 250° C. at an outlet of the extruder. Next, the resin was water-cooled and solidified, and then pelleted with a rotary cutter. During this process, the vent ports were connected to a vacuum pump and controlled to have a pressure of 500 Pa there. The thermoplastic resin composition thus obtained had its deflection temperature under load (of 1.80 MPa) measured, and was evaluated by a light resistance test (ΔE*), by the methods described above. The results are summarized in the following Table 1.

### First to Third Comparative Examples

A thermoplastic resin composition was produced and evaluated in the same way as in the first example except that pellets of Component (A) shown in the following Table 1 were used and that the respective components were mixed together to have the formulation of the thermoplastic resin composition shown in Table 1. The results are summarized in the following Table 1.

TABLE 1

| | | | | | Example | | Comparative Example | | |
|---|---|---|---|---|---|---|---|---|---|
| Table 1 | | | Composition [mol %] | | 1 | 2 | 1 | 2 | 3 |
| Formulation | Component (A) | D7340R | ISB/CHDM = 70/30 | [mass %] | 90 | 90 | 25 | 50 | 100 |
| [mass %] | | D5380R | ISB/CHDM = 50/50 | [mass %] | 10 | 10 | 75 | 50 | 0 |
| of | | Composition Ratio (ISB/CHDM) | | | 68/32 | 68/32 | 55/45 | 60/40 | 70/30 |
| Thermoplastic | | After Two Compounds Are Mixed | | | | | | | |
| Resin | Component (B) | Irganox1010 | | [mass %] | 0.1 | 0.1 | 0.1 | 0.1 | 0.1 |
| Composition | Component (C) | BHT | | [mass %] | 0.01 | 0.01 | 0.01 | 0 | 0 |
| | Component (D) | AS2112 | | [mass %] | 0.05 | 0.05 | 0.05 | 0.05 | 0.05 |
| | Component (E) | LA-29 | | [mass %] | 0 | 0 | 0.1 | 0.1 | 0.1 |
| | | LA31 | | [mass %] | 0.1 | 0.09 | 0 | 0 | 0 |
| | Component (F) | Tinuvin770DF | | [mass %] | 0 | 0 | 0.05 | 0.05 | 0.05 |
| | | LA57 | | [mass ppm] | 0.1 | 0.09 | 0 | 0 | 0 |

| | | | | | | |
|---|---|---|---|---|---|---|
| Evaluation Results | Deflection Temperature [° C.] | 99 | 99 | 85 | 90 | 102 |
| | under Load (1.80 MPa) | | | | | |
| | Light Resistance Test (ΔE*) | 1.3 | 1.4 | 2.8 | 3.1 | 1.7 |
| | SWOM700h | | | | | |
| | Light Resistance Test (ΔE*) | 1.9 | 1.2 | 1.5 | 2.6 | 2.7 |
| | SWOM1000H | | | | | |
| | Comprehensive Judgment | ∘ | ∘ | x | x | x |

What is claimed is:

1. An interior/exterior automotive trim component comprising
a thermoplastic resin composition including components (A), (B), (C), (D), (E), and (F), wherein
relative to 100 parts by mass of the component (A), the component (B) is 0.09-0.11 parts by mass, the component (C) is 0.001-0.015 parts by mass, the component (D) is 0.04-0.06 parts by mass, the component (E) is 0.09-0.11 parts by mass, and the component (F) is 0.09-0.11 parts by mass, where
the component (A) is a polycarbonate resin composition comprised of a molten mixture of a plurality of carbonate copolymers having respectively different copolymerization ratios,
the plurality of carbonate copolymers forming the polycarbonate resin composition each being comprised of structural units derived from two or more dihydroxy compounds,
the component (A) including, as the structural units derived from the dihydroxy compounds, a constitutional unit derived from a dihydroxy compound expressed by the following general formula (1) and a constitutional unit derived from cyclohexane dimethanol,
the ratio of the content of the constitutional unit derived from the dihydroxy compound expressed by the following general formula (1) to the content of the constitutional unit derived from cyclohexane dimethanol being represented as a molar ratio of 67/33 to 69/31,
the component (B) is a hindered phenol based antioxidant with a molecular weight of 1100-1200,
the component (C) is dibutyl hydroxy toluene,
the component (D) is tris(2,4-di-t-butylphenyl) phosphite,
the component (E) is a benzotriazole based light stabilizer with a melting point of 190-210° C., and
the component (F) is a hindered amine based light stabilizer with a melting point of 125-135° C.

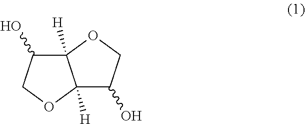

2. The interior/exterior automotive trim component of claim 1, wherein
the component (F) is a hindered amine based light stabilizer having a piperidine structure.

3. The interior/exterior automotive trim component of claim 2, wherein
the component (F) is a hindered amine based light stabilizer having a plurality of piperidine structures.

4. The interior/exterior automotive trim component of claim 3, wherein
the plurality of piperidine structures of the component (F) are linked to a single alkane chain via an ester bond.
